(19) United States
(12) Patent Application Publication
(10) Pub. No.: US 2021/0264540 A1
(43) Pub. Date: Aug. 26, 2021

(54) Appearing Social Media APP

(71) Applicant: Phillip Torio, Ronkonkoma, NY (US)

(72) Inventor: Phillip Torio, Ronkonkoma, NY (US)

(21) Appl. No.: 16/798,225

(22) Filed: Feb. 21, 2020

(51) Int. Cl. G06Q 50/00; H04N 7/14; G06Q 20/10; G06Q 20/12

(52) U.S. Cl. CPC G06Q 50/01; G06Q 20/123; G06Q 20/102; H04N 7/147

(57) ABSTRACT

A system for providing a video chat social media platform is disclosed. The system includes a web server, a performance computer, a plurality of mobile devices executing a video chat social media mobile application. The video chat social media mobile application includes a command processor, a user I/O interface, a web browsing interface, and a video decoder. The web server includes a streaming data processor, a web interface, a streaming data engine, a fan holding queue processor coupled to a fan holding queue, a fan account processor, and contest processor. The performance computer includes an image controller, a web upload interface, and video data interface.

### TECHNICAL FIELD

This application relates in general to a system and method for providing a social media application, and more specifically, a system and method for providing a social media application that provides performance streaming data to mobile devices.

### BACKGROUND

A social media platform solely based on live video chats between fans and public figures has marketing value for these public figures. The public figure may wish to limit the number of fans that are involved in a video chat at any one time to permit fans present an opportunity to interactively engage with the public figure. Providing a mechanism to provide a video chat between the public figure and large number of fans in an effective and equitable way currently not part of a social media platform.

Other mechanisms are needed that increase the experience for the fans while attempting to maximize revenue generated from the video chat. Mechanisms related to providing user accounts, payment mechanism, and interest generating activity before the video chat are also absent from existing social media platforms.

The present invention attempts to address the existing limitations in systems for providing a social media application that provides performance streaming data according to the principles and example embodiments disclosed herein.

### SUMMARY

In accordance with the present invention, the above and other problems are solved by providing systems and methods for providing a social media application that provides performance streaming data according to the principles and example embodiments disclosed herein.

In one embodiment, the present invention is a system for providing a video chat social media platform. The system includes a web server, a performance computer, a plurality of mobile devices executing a video chat social media mobile application. The video chat social media mobile application includes a command processor, a user I/O interface, a web browsing interface, and a video decoder. The web server includes a streaming data processor, a web interface, a streaming data engine, a fan holding queue processor coupled to a fan holding queue, a fan account processor, and contest processor. The performance computer includes an image controller, a web upload interface, and video data interface.

The great utility of the invention is that systems and methods for providing a social media application solves is the need for large numbers of fans to connect to public figures. The systems and methods for providing a social media application guarantees fans that buy into an access queue for one on one live virtual interactions with their favorite public figures (celebrities, entrepreneurs, music executives, entertainers, talent agents, sport scouts, fitness professionals, athletes etc . . . . ).

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a social media platform performance streaming data to fans according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a user screen shot of a mobile application to provide performance streaming data to fans according to the present invention.

FIG. 4 illustrates another embodiment of a user screen shot of a mobile application to provide performance streaming data to fans according to the present invention.

FIG. 5 illustrates computing system of software components providing performance streaming data to fans according to the present invention.

FIG. 6 illustrates flowchart for method executed on a web server to provide performance streaming data to fans according to the present invention.

FIG. 7 illustrates flowchart for method executed on a web server to provide a contest for access to performance streaming data to fans according to the present invention.

### DETAILED DESCRIPTION

This application relates in general to a system and method for providing a social media application that provides performance streaming data to mobile devices.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The term “user” and “fan” refers to an entity, e.g. a human, that operates a mobile device according to the present invention in order to bring about a desired effect or outcome, particularly provide the user an ability to support an instrument. In a particular case, the user is one that receives streaming data from a server. For such a user, the terms “user” and “fan” may be used herein interchangeably.

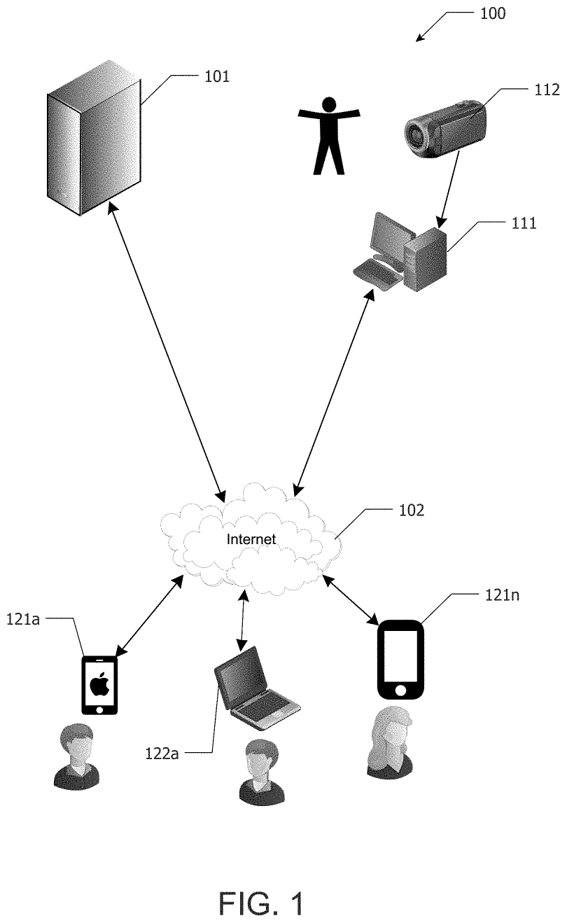

In general, the present disclosure relates general a system and method for providing a social media application. To better understand the present invention, FIG. 1 illustrates an example embodiment for a social media platform performance streaming data to fans according to the present invention.

Social media platform 100 is based solely on live video chats between fans and public figures. The social media platform is constructed using a web server 101, a performance computer 111 coupled to a video camera 112, and a plurality of fans using mobile devices 121a-n and similar computing devices 122a-m. All of these computing devices are communicatively coupled to the internet 102 to provide connectivity between these devices as needed.

The public figure utilizes the performance computer 111 to choose the amount of people allowed entered into their video chat, the length of time each person receives chatting with them and also the price per each person entering their live chat. These configuration settings are communicated to web server 101 for use when fans connect using their mobile devices 121a-n. When a fan enters the live video chat, he or she will be entered into a fan holding queue. Web server 101 will maintain a timer for each fan in the fan holding queue that will be displayed on the screen of the mobile devices to tell the fan how long it is until it is that particular fan may enter the video chat. Fans that are waiting can also use a text chat and message component to communicate with each other while waiting. While the performance computer is described herein as a general purpose computing system, a public figure may use any computing device, including smartphones, tablets, laptops, and desktop systems so long as device possesses the necessary applications and possesses a camera or camera interface to support the functionality disclosed herein.

If a fan is not quick enough to get into the fan holding queue, the fan can still watch the live video chats through a main feed of performance streaming data provided to all via their mobile devices 121a-n. Each fan's feed will be based on the public figures that they follow. A fan's feed may show both on going live chats from followed favorite public figures as well as previous video chats that were previously recorded.

Chatting with public figures isn't the only thing social media platform 100 offers. Social media platform 100 also provides artist and entertainers opportunities to boost their careers, dreams and passions. For example, Social media platform 100 may have music executive's, A&R's and producers hosting live video chats like mentioned before giving artist a chance to showcase their music to them by simply sending an MP3 or even a music video live in the chat for everyone to hear. Not only will the artist get exposure from this but they can potentially land a record deal through this as well.

Social media platform 100 may provide a mechanism for any public figure with a following to utilize. These public figures may be able to generate money while engaging with their fans live. Public figures keep larger portion of the profits from a video chat session, such as 80%, and the remaining smaller portion of the profits, i.e. 20%, as a service fee for using the social media platform 100. Social media platform 100 may also have non-profit organizations integrated in the platform to permit a public figure to donate their proceeds a charity of their choice. This social media platform 100 may provide a way for the public figure to give back to the community.

Social media platform 100, which typically charges fans to participate in a video chat, may also include monthly challenges or contest for the fans to obtain no charge access to the fan holding queue. If a fan wins one of these monthly challenges, social media platform 100 may give that fan a credit to enter any live video chat with a public figure of their choice for free.

The social media platform provides personalized profile pages for the “User” or Fan. This profile page may show all of the fans recent challenge post/videos that the user post to their page. This profile page may also show who a fan follows and who follows the fan, if any. The profile page may include a recent activity tab that shows all recent post from all the people you follow for the last 24 hours.

Personalized profile pages for the public figures works in a similar manner as a fan's profile page; however the public figure's profile page may also include any on-going live video chat or the most recent live video chat as well as any other videos the public figure posts to their personal page. This profile page is also where public figures are able to set up a fan holding queue for a live feed when they are preparing to go live. When a fan has entered a live video chat, the web server may record the particular portion of the live chat, whether the entire time the fan is in the live video chat or only portions in which the fan is personally interacting with the public figure. This recorded video clip may be provided to the fan on the personalized profile page for sharing, viewing, and downloading as desired.

A notification and a direct message button may be present on any page a fan visits that provides access to a direct message from any location. The notifications show fans if anyone liked or commented on one of the fan's challenge videos. The direct message gives the fan or public figure an ability to send messages to any person using the platform. The recipient of the direct message indicates whether they want to accept or decline the message in cases where the recipient is not following the fan back.

Social media platform 100 may provide a personalized virtual interaction with public figures to fans. Premium users may buy into the queue to purchase time elapsed slots to guarantee live interaction with public figures. Individuals can showcase their talents live to professionals in their field of choice and receive reactions from both the public and the professionals. Monthly challenges will provide an individual to get in any queue for free if they win the challenge. Only verified accounts will be able to host live video chat rooms for profit, free or donations.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

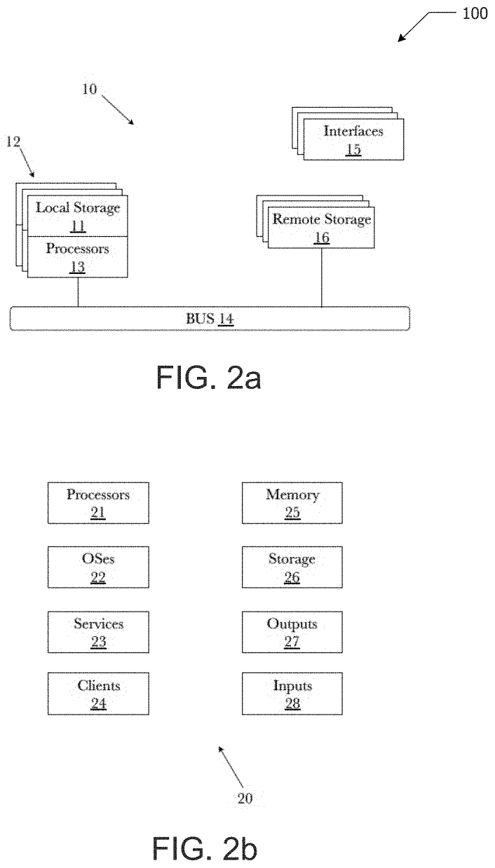

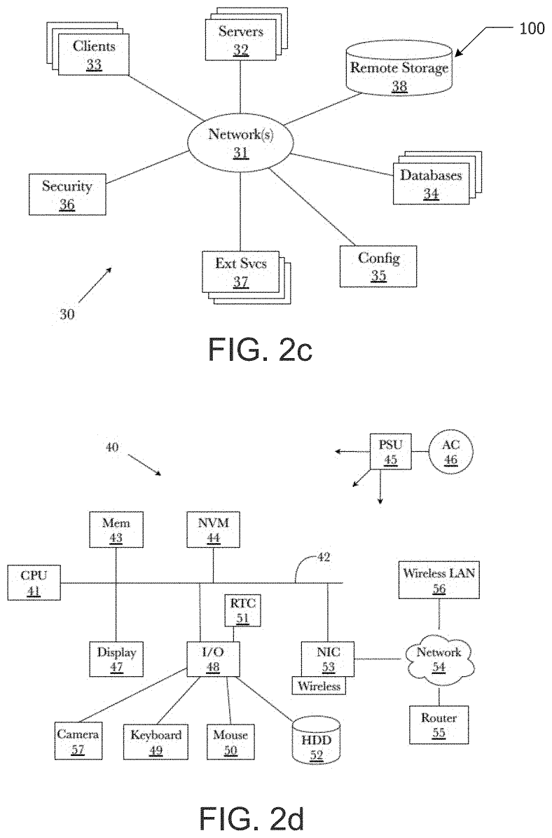

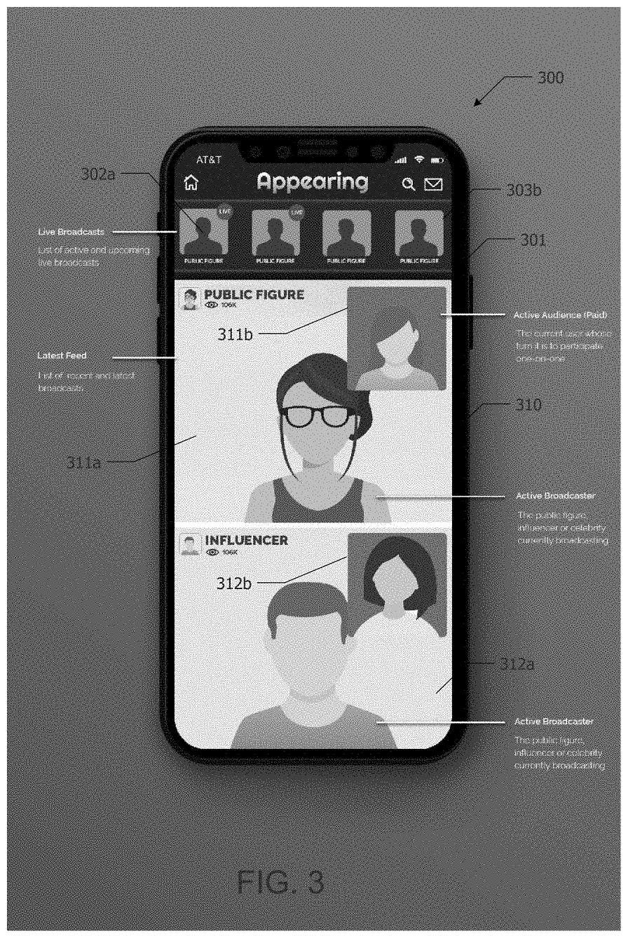

Referring now to FIG. 2a, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

In some aspects, systems may be implemented on a standalone computing system. Referring now to FIG. 2b, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 2a). Examples of storage devices 26 include flash memory, magnetic hard drive, CD-ROM, and/or the like.

In some aspects, systems may be implemented on a distributed computing network, such as one having any number of clients and/or servers. Referring now to FIG. 2c, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in Fig. B. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

FIG. 2d shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

FIG. 3 illustrates an example embodiment of a user screen shot of a mobile application to provide performance streaming data to fans according to the present invention. An example app screen 300 represents performance streaming data available for viewing. The app screen 300 contains a scrollable available performance streaming data field 301 that contains a plurality of performance data streams, both live feeds 302a-b and upcoming feeds 330a-b.

A fan scrolls thru the available performance streaming data field 301 and clicks on a particular feed 302a-b, 303a-b to be streamed to the particular fan's mobile device. When selected, the mobile app contacts the web server 101 to confirm the payment for access to the fan holding queue is obtained or that a previously purchased credit is associated with the fan's account for use when the fan enters the video chat, or fan holding queue.

The main body 310 of screen consists of a plurality of video chat data streams 311a-b, Each video chat data stream 311a-b consist of a main data stream 312a and a smaller active audience thumbnail 312b. The main data stream 312a contains the video data showing the public figure who created the video chat session. The active audience thumbnail 312b presents a video data stream for one of the fans currently in the video chat session who is currently interacting with the public figure. Most mobile devices possess a front facing camera that may be activated by the app executing on the mobile device. Video data from this fan's device camera may be transmitted over the internet 102 to the web server 101 for inclusion of the data feed sent to all fans.

One of the video chat data streams 311a-b currently part of the main body of the screen will be in an active mode in which audio data that is part of that particular video chat data stream is played to the fan via speakers that are part of the mobile device, headphones coupled to the mobile device, or external speakers connected using a Bluetooth™ connection. A fan may switch between the video chat data streams 311a-b in the main body of the screen.

Signing up on appearing will be as simple as signing up with your email address or signing in using your Facebook account, choosing a username, and uploading a profile picture. Signing up as a fan provides an option to upload a debit/credit card to keep it on file so that the fan may quickly try to gain access to the queue. Fans may also have the option to just use a credit card as needed if they do not want to keep it on file.

When public figures make an account, it may utilize a similar process as described above with respect to fans. However, public figures may also fill out a form with links to all of their social media accounts and also upload a picture of their photo ID so the social media platform 100 may verify their identity. Also, public figures will have to provide banking information to enable profits to be paid instantly as soon as a session is over.

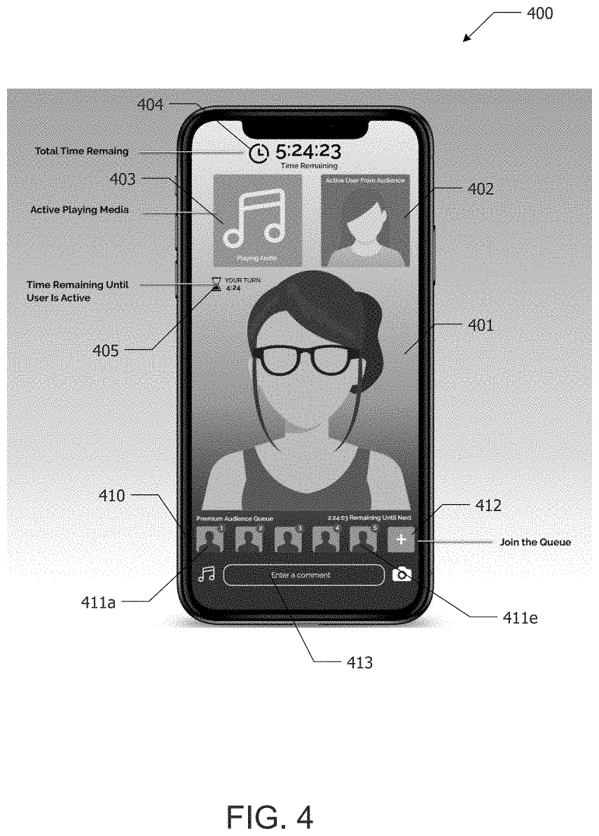

FIG. 4 illustrates another embodiment of a user screen shot of a mobile application to provide performance streaming data to fans according to the present invention. App screen 400 shows a fan while in the fan holding queue. The main video image 401 presents incoming performance streaming data generated by the public figure. Smaller thumbnail image 402 shows video chat streaming data of a fan currently interacting with the public figure.

Fans 422a-e from the fan holding queue is shown in the queue field 410 and includes a join button 412. The main screen 401 also includes an active media image 403 to display the identity of any music or other media currently playing as part of the video chat. The active media image 403 may be a static image of an album cover or similar identifying image. The active media image 403 may also present streaming video such a music video, movie, or similar video sequence.

The main screen 401 contains two count down clocks: time until chat entry countdown 405 and total time remaining 404 for the entire video chat session. These clocks keeps fans informed of where they are in the video chat session process as it occurs. The main screen 401 also contains a comment field 413 to allow the fan to enter a text comment using ordinary text input mechanisms supported be the mobile device that will be shared with the fans and public figure that are part of the video chat session.

While the example screens of FIGS. 3-4 are presented on a mobile device such as a smartphone for both a fan and public figure using the social media platform, other devices with differing screen sizes and arrangements may also be supported. The mobile application may be an application that is developed and provided to fans via any of the app stores, such as ones provided by Apple™, Google™, and Microsoft™. The mobile application may also be rendered using a web browser on a mobile device where the web server 101 identifies the type of device a fan is using and provides a matching performance streaming data feed that matches the device. Other streaming data mechanisms may also be used that are consistent with the present invention as defined in the attached claims.

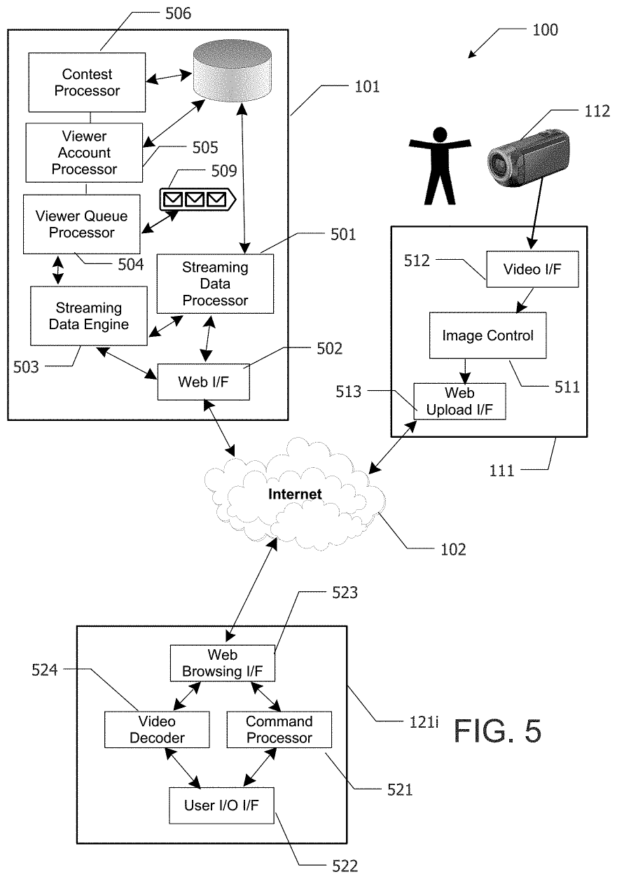

FIG. 5 illustrates computing system of software components providing performance streaming data to fans according to the present invention. Social media platform 100 may be constructed using a set of software elements executing within the web server 101, the performance computer 111, and mobile devices 121a-n.

The web server 101 may include a streaming data processor 501, a web interface 502, a streaming data engine 503, fan queue processor 504, a contest processor 506, data storage 507. and a fan holding queue 509.

Performance computer 111 may include an image controller 511, video input interface 512, and web upload interface 513.

Mobile application 122i may include a command processor 521, user I/O interface 522, web browsing interface 523, and video decoder 524.

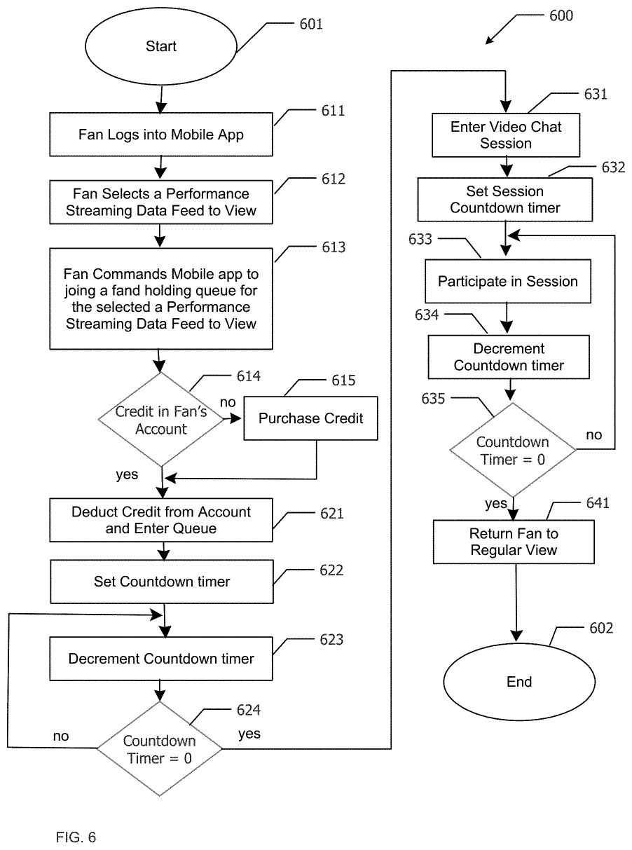

FIG. 6 illustrates flowchart for method executed on a web server to provide performance streaming data to fans according to the present invention. The method for providing a social media application 600 begins 601 when a fan logs into a mobile application in step 611. The fan selects, in step 612, one of a plurality of performance streaming data feeds from public figures being followed. In step 613, the fan commands the mobile application to join a fan holding queue associated the selected performance streaming data feed. Test step 614 determines whether the account associated with the fan possess sufficient credits to enter the fan holding queue. If test step 614 determines that there are not enough credits in the fan's account, the fan may purchase credits in step 515 before proceeding.

When test step 614 determines that there are not enough credits in the fan's account, the process continues to step 621 where credits are deducted from the fan's account. A countdown time is calculated until a point in time when the fan may enter a video chat session in step 622. The countdown timer is decremented in step 623 and test step 624 determines whether the countdown time has reached zero. If the countdown timer has not reached zero, the processing returns to step 623 until the timer reaches zero.

When test step 624 determines the countdown timer has reached zero, the fan is placed into an active video chat session in step 631. A session countdown timer is set in step 632, wherein the session countdown timer defines how much time remains for the fan to participate in the active video chat session. In step 633, the fan participates in the active video chat session. The fan participates by being able to speak to the public figure in the active video chat session as well as send messages directly to the public figure so that he or she may respond to fans currently in the active video chat.

The session countdown timer is decremented in step 634 before test step 635 determines whether the countdown timer has reached zero. If test step 635 determines that the countdown timer has not reached zero, the process returns to step 633 to permit the fan to continue participating in the active video chat session.

When test step 635 determines that the countdown timer has reached zero, the fan's time in the active video chat has ended. The fan returns to a normal state in step 641 where the fan may continue to view the performance streaming data feed until its conclusion when the process ends 602.

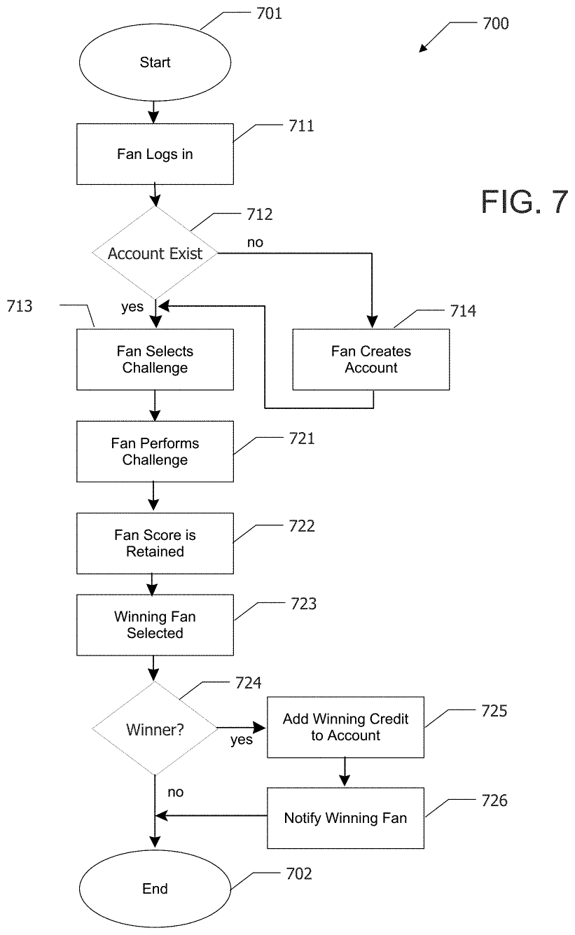

FIG. 7 illustrates flowchart for method executed on a web server to provide a contest for access to performance streaming data to fans according to the present invention. The challenge or contest process 700 begins 701 when a fan logs into the mobile application in step 711. Test 712 determines whether the account exists to permit the fan to create an account in step 714 if necessary. If test step 712 determines a valid account exists or one has been created, the fan selects a contest of challenge to play. In these processes, a challenge and a contest are essentially the same depending upon whether the fan must perform a task to determine the outcome or whether the outcome is simply a random selection.

Once selected, the fan plays the challenge in step 721. As noted above, the challenge may require the fan to interact sin some manner with the challenge based upon information displayed on the mobile device and inputs received by the mobile application from the fan. These challenges may include trivia questions, puzzles, number games random actions such as stopping a spinning wheel with a click on the screen and the like.

In a preferred embodiment, challenges may be dance challenges, slam dunk contest, comedy challenges, singing challenges and the like. People participating in these challenges upload a video of themselves performing a particular challenge and hash-tagging the uploaded video assisting its classification into an appropriate category on a challenge page. These challenges are created by the social media platform. Public figures may also create their own challenges if desired. A prize given by the social media platform for challenges may include a free entry to a fan holding queue of any public figure that the fan chooses. Public figures may give away whatever they would like when a fan wins their challenge. The challenges may run for any length of time as defined when the challenge is created. Typically, a challenge may run all month where the following month include new challenges to enter.

In step 722, an outcome or score is determined for the fans interaction with the challenge so that one or more winning fans may be selected in step 723. Test step 724 determines whether this particular fan is a winner such that credits may be added to the fan's account in step 725 and the fan notified of the winning challenge in step 726. The fan may be notified by a notification from the mobile application, an email, an SMS text message, or similar means of communication. Once any updates for winners are complete, the process ends 702.

The skilled person will be aware of a range of possible modifications of the various aspects described above. Accordingly, the present invention is defined by the claims and their equivalents.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing a video chat social media platform, the system comprises:
a web server, the web server comprises:
a streaming data processor for combining streaming data sources into a single performance streaming data feed;
a streaming data engine for providing a live performance streaming data feed to fans, the live performance streaming data feed includes live performance streaming data from a public figure and live performance streaming data from one or more fans;
a fan holding queue processor coupled to a fan holding queue; and
a fan account processor for providing fan account set up and payment processing; and
a contest processor for providing fan challenges in which one or more fans obtains access to the fan holding queue;
a performance computer, the performance computer comprises:
an image controller;
a web upload interface for providing performance video data of the public figure to the web server; and
a video data interface for obtaining performance streaming data from the public figure for inclusion in the performance streaming data feed;
a plurality of mobile devices executing a video chat social media mobile application, the video chat social media mobile application comprises:
a command processor;
a user I/O interface;
a web browsing interface; and
a video decoder.

2. The system according to claim 1, wherein the web server further comprises:
a web interface;
a fan account processor; and
a contest processor.

3. The system according to claim 1, wherein the fan holding queue processor requires payment from the fan account to obtain access to the fan holding queue.

4. The system according to claim 1, wherein the video chat social media mobile application further comprises a fan video input for accepting performance video data from the fan for inclusion of the performance streaming data feed.

5. The system according to claim 1, wherein the web server provides historical performance streaming data feeds from the public figure for access by fans via the plurality of mobile devices executing a video chat social media mobile application.

6. The system according to claim 1, wherein the web server provides historical performance streaming data feeds from the public figure that includes a particular fan for access from a personalized profile page.

7. A method for providing a video chat social media platform, the method comprising:
receiving a fan login request from a mobile application;
selecting one of a plurality of performance streaming data feed, the performance streaming data feed of a public figure having a corresponding fan holding queue, an active video chat, and performance streaming data;
receiving a request to enter the fan holding queue associated with the one of a plurality of performance streaming data feeds;
placing a fan into the fan holding queue with a calculated countdown clock;
when the calculated countdown clock is zero, placing the fan into active video chat associated with the one of a plurality of performance streaming data feed; and
removing the fan from the active video chat after a predetermined time.

8. The method according to claim 7, wherein the method further comprises obtaining payment from the fan account prior to entry into the fan holding queue.

9. The method according to claim 8, wherein the method further comprises:
receiving performance streaming data of the public figure;
receiving performance streaming data of one or more fans; and
combining the various performance streaming data and active video chat data into the performance streaming data feed.

10. The method according to claim 9, wherein the active video chat comprises audio streaming data from a plurality of fans currently chatting with the public figure, the performance streaming data from at least one of the plurality of fans currently chatting with the public figure, and performance streaming data of the public figure.

11. The method according to claim 7, wherein the web server further
receives uploaded video clips from one or more fans as part of a challenge; and
awarding one free access to the fan holding queue to at least one of the one or more fans who uploaded at least one video clip.

12. The method according to claim 7, wherein the method further comprising:
providing historical performance streaming data feeds from the public figure that includes a particular fan for access from a personalized profile page.
